(19) United States
(12) Patent Application Publication
(10) Pub. No.: US 2010/0229717 A1
(43) Pub. Date: Sep. 16, 2010

(54) Linear Compressor With Sintered Bearing Bush

(75) Inventor: Jan-Grigor Schubert, Senden (DE)

Correspondence Address: BSH HOME APPLIANCES CORPORATION;INTELLECTUAL PROPERTY DEPARTMENT, 100 BOSCH BOULEVARD, NEW BERN, NC, 28562, US

(73) Assignee: BSH Bosch und Siemens Hausgerate GmbH, Munchen (DE)

(21) Appl. No.: 12/223,997

(22) PCT Filed: Jan. 19, 2007
(86) PCT No.: PCT/EP2007/050537

§ 371 Date: Feb. 25, 2010

(30) Foreign Application Priority Data
Feb. 28, 2006 (DE) 10 2006 009 268.6

(51) Int. Cl. F16J 10/00; B23P 15/00; F16C 32/06

(52) U.S. Cl. 92/170.1; 29/888.02; 384/100

(57) ABSTRACT

A linear compressor includes a piston housing having a plurality of gas permeable openings therein and a compressor piston configured for reciprocatory motion therein along an axis, the compressor piston being supported in the piston housing by gas flowing through the openings and wherein the housing wall is porous.

The present invention relates to a linear compressor, comprising a piston housing and a compressor piston movable back and forth therein along an axis, wherein the compressor piston is supported in the piston housing by means of a housing wall having openings and by means of a gas flowing through the openings; to a refrigeration device; to a method for producing a linear compressor and to a gas pressure bearing which includes a rotatable and/or displaceable body and a bearing element, wherein the body is supported in the bearing element by means of a bearing wall having openings and by means of a fluid flowing through the openings.

With oil-free linear compressors it is known to separate a compressor piston from the cylinder wall by a cushion of gaseous refrigerant which flows inwardly into the cylinder through micro-bores through a cylinder wall. For an oil-free bearing of this type, the so-called gas pressure bearing, a continuous supply of gas is required in order to maintain the cushion. If the gas cushion is too thin or inhomogeneous, friction occurs through contact of the compressor piston with the cylinder wall. The friction leads to wear and loss of performance of the linear compressor.

Known solutions provide a multiplicity of micro-bores formed in the cylinder wall in order to form the gas cushion. As is known from U.S. Pat. No. 6,575,716, a peripheral groove with a central supply bore may also be provided in the cylinder wall. As compared to the micro-bores, the central peripheral groove has the disadvantage of uneven support capacity over the circumference and higher gas consumption. On the other hand, the micro-bores suffer an increased danger of blockage by impurities and require an upstream filter for the gas.

It is therefore an object of the present invention to provide a linear compressor and a refrigeration device with which reliable operation even over a long period can be achieved at low cost.

It is further an object of the present invention to specify a method for producing a linear compressor or a refrigeration device with a linear compressor, whereby a linear compressor or a refrigeration device can be produced at low cost in a simple manner, so that reliable operation even over a long period is made possible. In addition, it is an object of the invention to specify a method for cooling merchandise which allows especially rapid, reliable and energy-saving cooling of merchandise.

It is further an object of the invention to provide a gas pressure bearing which can be produced economically, operates reliably and is not susceptible to malfunctions.

These objects are achieved according to the invention by the linear compressor, by the refrigeration device, by the gas pressure bearing, by the method for producing the linear compressor, by the method for cooling merchandise and by the refrigeration device, as specified in the respective independent claims. Further advantageous configurations, in isolation or combined with one another in any desired manner, are the subject matter of the respective dependent claims.

The linear compressor according to the invention comprises a piston housing and a compressor piston movable back and forth therein along an axis, the compressor piston being supported in the piston housing by means of a housing wall having openings and by means of a gas flowing through the openings, and the housing wall being porous.

The compressor piston is supported in the piston housing by a gas cushion built up by the gas flow between the compressor piston and the piston housing. For this purpose gas is forced through the openings of a housing wall which serves as a bearing surface for the compressor piston. The openings enable gas to be supplied and therefore a bearing support to be provided at the locations where contact of the compressor piston with the piston housing would otherwise lead to wear. In order to build up the gas flow, the housing wall is porous.

In this context the term “porous” means that, unlike the known bore-holes, which pass through the housing wall in a substantially rectilinear manner and allow a gas flow only along the bore direction, the openings can also receive a lateral gas flow. Through the porosity, the gas inside the housing wall can flow in different, in particular more than two, directions. In particular, the gas can also flow parallel to a surface of the housing wall. The gas flow through the porous housing wall may be diffusive, i.e. the direction of the flowing gas changes locally from pore to pore and does not remain substantially unchanged, as in the case of a bore-hole in which a tubular flow forms. The porosity of the housing wall may be produced, in particular, by a granular structure of the housing wall. The porosity of the housing wall may be produced through bonding of a multiplicity of granules which are baked or sintered to one another.

The advantage of this porosity is that, in the event of blockage of a pore, a multiplicity of neighboring pores are available, into which the local gas flow can be diverted. Unlike the case with the known drilled openings, a local blockage of a single pore does not lead to blockage of the whole channel over the whole thickness of the housing wall, but only to blockage at the local site within the housing wall. As a result, the gas pressure bearing is far less susceptible to malfunction through contamination. An upstream filter for the gas can be dispensed with. Through a suitable choice of the porosity, the gas flow through the housing wall can be predefined very uniformly, whereby uniform bearing forces are produced. Uniform bearing forces provide good guidance in the bearing, and the magnitude of the gas flow required for adequate bearing support can be reduced.

The housing wall advantageously has open pores. Because of the open porosity, the gas can flow within the housing wall transversely to the main flow direction of the gas in an especially simple manner, if an opening at one location is blocked. Through the property of the housing wall of also permitting a lateral gas flow, the effective total number of flow channels available to the gas flow is considerably increased.

In a particular configuration the housing wall is sintered.

Through a suitable choice of the relevant parameters during sintering, the porosity, and therefore the flow behavior, for example the flow resistance, of the housing wall can be precisely tailored to the particular requirements of supporting the cylinder piston in the piston housing.

The local flow resistance through the housing wall advantageously changes along the axis of the piston housing. Through adaptation of the porosity along the axis, the bearing forces at a given location, which may vary in dependence on the position of the compressor piston, can be taken into account. In particular in zones where high bearing forces are required, a comparatively low through-flow resistance is to be selected, while a correspondingly higher local through-flow resistance can be specified in zones where only low bearing forces arise. By means of profiling of the flow resistance through the housing wall, the gas cushion can be adapted. The gas consumption required for adequate bearing support can thereby be minimized.

In an advantageous configuration the porosity, in particular the material content, of the housing wall changes along the axis. In this case the mean pore sizes, the distribution of pore sizes, the ratio of open pores to closed pores and the proportion of material to free spaces, i.e. the material content, among other parameters, can be changed. The material content may be from 70% to 99%, in particular from 80% to 90%. The porosity can be influenced, for example, by the selection of the grains to be bonded to one another in the sintering process, or by the temperature profile over time during the sintering process.

It is also advantageous to vary the thickness of the housing wall. The local through-flow resistance can also be influenced, or the profile of the bearing forces acting on the compressor piston can be influenced or predefined, via the thickness of the housing wall.

In a particular configuration the flow resistance, in particular the thickness of the housing wall, varies over the length of the piston housing within a range from 1.5 to 6, in particular within a range from 2 to 4.

The length of the piston housing should be understood to mean the length corresponding to the stroke of the compressor piston in the piston housing, that is, the length over which support for the compressor piston in the piston housing is required.

For example, the local through-flow resistance increases along the axis in the direction of retraction of the compressor piston from the piston housing. This adaptation of the local through-flow resistance is suitable for cases in which the bearing forces required for the compressor piston in the retracted state of the compressor piston from the piston housing are smaller than in the “telescoped” state, i.e. when the compressor piston is fully inserted in the piston housing.

The housing wall may be configured as a cylinder liner. In this case the cylinder liner may be inserted in the piston housing in such a manner that an annular cavity, which may be charged with the gas through a gas connection, is formed between the piston housing and the cylinder liner.

The housing wall may be made from a metal or from a ceramic material.

The compressor piston may be supported in an oil-free manner in the piston housing.

The housing wall has pores the mean diameter of which is within the range from 0.005 mm to 0.100 mm, in particular in a range from 0.01 mm to 0.06 mm, preferably in a range from 0.02 mm to 0.04 mm.

Through such dimensioning of the pore sizes an especially uniform gas flow through the housing wall can be effected, contributing to a uniform and reliable gas bearing whereby wear on the compressor piston and/or the housing wall is reduced.

In a configuration, the maximum diameter of the pores is less than 0.13 mm, in particular less than 0.08 mm, preferably less than 0.05 mm.

The refrigeration device according to invention includes the linear compressor according to the invention. Because of the operating reliability, non-susceptibility to malfunction and simple manufacturability of the linear compressor, the refrigeration device, for example a refrigerator, a freezer or an air-conditioning system, in particular an air-conditioning system for motor vehicles, operates in an especially malfunction-proof and reliable manner and can also be simply produced. In particular, because of the particular characteristics of the linear compressor according to the invention, no pre-filter for the gas is required, further reducing the manufacturing cost of the refrigeration device.

The gas pressure bearing according to the invention comprises a rotatable and/or displaceable body and a bearing element, the body being supported in the bearing element by means of a bearing wall having openings and by means of a fluid flowing through the openings, and the bearing wall being porous.

As already described above with reference to the linear compressor comprising the compressor piston, the piston housing and the housing wall, the gas pressure bearing comprising the body, the bearing element and the bearing wall has especially advantageous properties with regard to improved non-susceptibility to malfunction, and with regard to uniform support of the rotatable and/or displaceable body in the bearing element. In addition, a consumption of gas for producing the gas cushion for the bearing can be reduced.

Through the diffusive character of the gas flow through the bearing wall, which also permits a gas flow transverse to the main flow direction and allows zonally spontaneous variation of a flow path, an especially low susceptibility to malfunction of the bearing, and therefore high reliability, are achieved.

The bearing wall may be open-pored. The bearing wall is advantageously sintered.

Through the specification of suitable parameters of the sintering process, the porosity, in particular the size of the pores and the distribution thereof, or the ratio of the number of open pores to closed pores, can be adapted to the particular application of the bearing. In particular, it is possible to produce bearing elements with almost any desired form in a simple and low-English cost manner. The bearing wall may be made of a metal or of a ceramic material.

The bearing wall has pores the mean diameter of which is within the range from 0.005 mm to 0.200 mm, in particular in a range from 0.01 to 0.06 mm, preferably in a range from 0.02 mm to 0.04 mm. The maximum diameter of the pores may be less than 0.13 mm, in particular less than 0.08 mm, preferably less than 0.05 mm.

The porosity of the bearing surface may vary along a direction; in particular the material content, the pore sizes and other parameters may be varied as described.

The method according to the invention for producing a linear compressor or for producing a refrigeration device including a linear compressor, the linear compressor comprising a piston housing and a compressor piston movable back and forth therein along an axis, and the compressor piston being supported in the piston housing by means of a housing wall having openings and by means of a gas flowing through the openings, comprises the following process steps:
a) forming of a compressor piston and a piston housing with a housing wall;
b) sintering of the housing wall.

Unlike the prior art, which entailed comparatively complex and costly manufacture of the linear compressor, since the individual openings in the housing wall had to be produced individually, according to the present invention the housing wall is produced block-wise in a simple manner substantially by one sintering process step. The manufacturing cost is thereby considerably reduced.

The method according to the invention for cooling merchandise utilizes the refrigeration device according to the invention. It is able to cool and keep cool merchandise, in particular foodstuffs, in a rapid, reliable and energy-saving manner.

Further advantages and particular developments are explained in more detail with reference to the following drawing, which is intended not to restrict the invention but merely to illustrate it in an exemplary manner. In the drawing:

FIG. 1 shows schematically in cross section a linear compressor as known from the prior art;

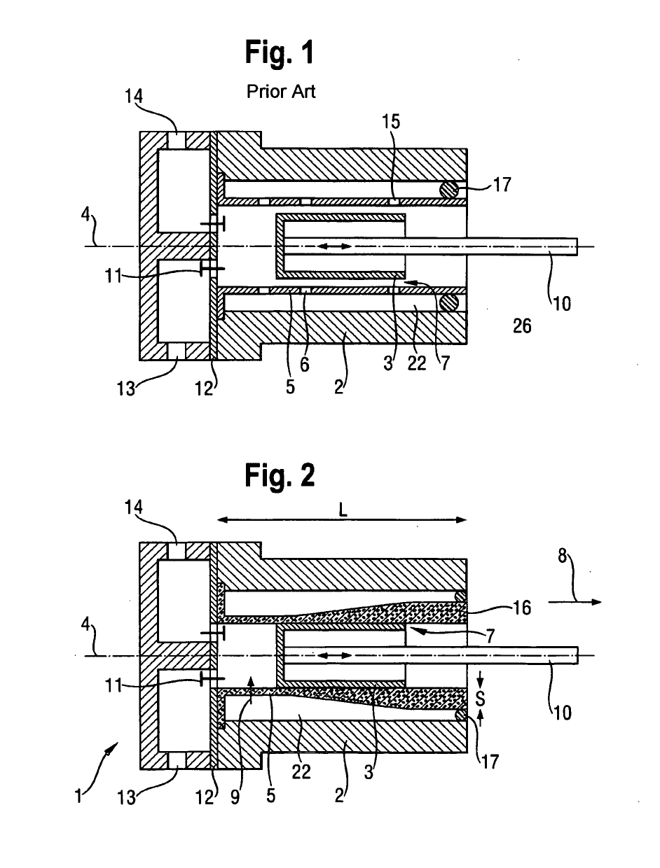

FIG. 2 shows schematically in cross section a linear compressor according to the invention, and

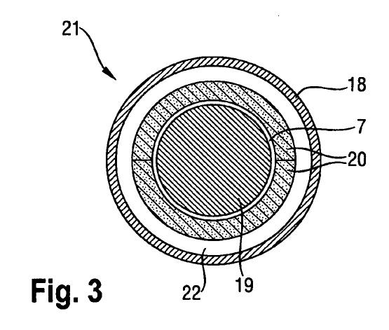

FIG. 3 shows schematically a gas pressure bearing according to the invention.

FIG. 1 shows in cross section a linear compressor as known in the prior art, with a piston housing 2 in which a compressor piston 3 is movable back and forth along an axis 4. The compressor piston 3 is supported by means of a housing wall 5 which has openings 6, a gas cushion 7 being built up between the compressor piston 3 and the housing wall 5 by means of a gas flowing through the openings 6. A cavity 22 between the housing wall 5 and the piston housing 2, which cavity 22 is charged with the gas, is sealed by means of an O-ring 17. Through the reciprocating motion of the compressor piston 3 effected by means of a piston rod 10, suction takes place at a suction connection 14 and compression at a pressure connection 13, with appropriate switching of the valves 11. The openings 6 are in the form of micro-nozzles 15 which are produced using opto-mechanical production methods.

FIG. 2 shows in cross section the linear compressor 1 according to the invention. In this case the compressor piston 3 is guided in a gas bearing bush 16, the housing wall 5 of which consists of sintered material which is porous and allows a gas flow 9 to pass through. The local flow resistance through the housing wall 5 changes along the axis 4 in that the thickness S of the housing wall 5 varies over the length L of the piston housing 2. In the concrete configuration, only relatively low bearing forces are required when the compressor piston 3 is retracted in the retraction direction 8, so that the thickness S of the housing wall 5 in FIG. 2 is greater on the right than on the left. Because of the porosity, a gas flow 9 can bypass contaminated pores locally, for which reason the entire flow path through the housing wall 5 is not blocked if a pore is closed, but only a section thereof.

FIG. 3 shows in cross section a gas pressure bearing 1 according to the invention, with a rotatable body 19 which is to be supported by means of a bearing element 18. The support is provided by means of a bearing wall 20 which here is configured in two parts. The bearing wall 20 is made from sintered material and has a porosity with pores having a mean diameter of 20 μm. A gas cushion 7, which generates the required bearing forces for the body 19, is produced by a gas flow through the bearing wall 20 towards the body 19.

As the flowing gas, the coolant utilized in the refrigeration device is advantageously used.

The invention relates to a linear compressor 1 and to a method for production thereof, comprising a piston housing 2 and a compressor piston 3 movable back and forth therein along an axis 4, the compressor piston 3 being supported in the piston housing 2 by means of a housing wall 5 having openings 6 and by means of a gas flowing through the openings 6, the housing wall 5 being porous, in particular sintered, characterized by high reliability in operation.

### LIST OF REFERENCES

1 Linear compressor
2 Piston housing
3 Compressor piston
4 Axis
5 Housing wall
6 Openings
7 Gas cushion
8 Retraction direction
9 Gas flow
10 Piston rod
11 Valve
12 Valve plate
13 Pressure connection
14 Suction connection
15 Micro-nozzle
16 Gas bearing bush
17 O-ring
18 Bearing element
19 Body
20 Bearing wall
21 Gas pressure bearing
22 Cavity
S Thickness of housing wall 5
L Length of piston housing 2

1-23. (canceled)

24. A linear compressor comprising a piston housing having a plurality of gas permeable openings therein and a compressor piston configured for reciprocatory motion therein along an axis, the compressor piston being supported in the piston housing by gas flowing through the openings and wherein the housing wall is porous.

25. The linear compressor according to claim 24 wherein the housing wall is open-pored.

26. The linear compressor according to claim 24 wherein the housing wall is sintered.

27. The linear compressor according to claim 24 wherein the local flow resistance through the housing wall varies along the axis.

28. The linear compressor according to claim 27 wherein the porosity of the housing wall, in particular the material content, varies along the axis.

29. The linear compressor according to claim 27 wherein the thickness of the housing wall varies throughout its length.

30. The linear compressor according to claim 27 wherein the flow resistance, in particular the thickness of the housing wall, varies over the length of the piston housing within a range from about 1.5 to about 6, in particular within a range from about 2 to about 4.

31. The linear compressor according to claim 27 wherein the local through-flow resistance along the axis increases in the retraction direction of the compressor piston from the piston housing

32. The linear compressor according to claim 24 wherein the housing wall is in the form of a cylinder liner.

33. The linear compressor according to claim 24 wherein the housing wall is formed from a metal.

34. The linear compressor according to claim 24 wherein the housing wall is formed from a ceramic material.

35. The linear compressor according to claim 24 wherein the compressor piston is supported in the piston housing in an oil-free manner.

36. The linear compressor according to claim 24 wherein the housing wall is formed with a plurality of pores and wherein the mean diameter of the pores is in the range from about 0.005 mm to about 0.100 mm, in particular in a range from about 0.01 mm to about 0.06 mm, preferably in a range from about 0.02 mm to about 0.04 mm.

37. The linear compressor according to claim 36 wherein the maximum diameter of the pores is less than about 0.13 mm, in particular less than about 0.08 mm, preferably less than about 0.05 mm.

38. A refrigeration device comprising a linear compressor including a piston housing having a plurality of gas permeable openings formed therein, and a compressor piston configured for reciprocatory motion within the piston housing along an axis thereof, the compressor piston being supported in the piston housing by gas flowing through the openings and wherein the housing wall is porous.

39. A gas pressure bearing comprising at least one of a rotatable body and a displaceable body; and a bearing element, wherein at least one of a rotatable body and a displaceable body is supported in the bearing element by a bearing wall formed with openings therein and a fluid flowing through the openings, wherein the bearing wall is porous.

40. The gas pressure bearing according to claim 39 wherein the bearing wall is open-pored.

41. The gas pressure bearing according to claim 39 wherein the bearing wall is sintered.

42. The gas pressure bearing according to claim 39 wherein the bearing wall is made of at least one of a metal and a ceramic material.

43. The gas pressure bearing according to claim 39 wherein the bearing wall is formed with a plurality of pores and the mean diameter of the pores is in the range from about 0.005 mm to about 0.100 mm, in particular in a range from about 0.010 mm to about 0.060 mm, preferably in a range from about 0.020 mm to about 0.040 mm.

44. The gas pressure bearing according to claim 43 wherein the maximum diameter of the pores is less than about 0.130 mm, in particular less than about 0.080 mm, preferably less than about 0.050 mm.

45. A method for producing at least one of a linear compressor and a refrigeration device including a linear compressor, the linear compressor comprising a piston housing and a compressor piston configured for reciprocatory movement therein along an axis, the compressor piston being supported in the piston housing by a housing wall having a plurality of openings formed therein and by a gas flowing through the openings, the method comprising the following steps:
forming a housing wall;
sintering the housing wall.

46. A method for cooling merchandise including the steps of:
providing a refrigeration device including a linear compressor having a piston housing with a plurality of gas permeable openings formed therein, and a compressor piston configured for reciprocatory motion therein along an axis, the compressor piston being supported in the piston housing by gas flowing through the openings and wherein the housing wall is porous;
placing merchandise for cooling inside the refrigeration device; and
operating the refrigeration device to cool the contents of the refrigeration device.
